(19) United States
(12) Patent Application Publication
(10) Pub. No.: US 2010/0119777 A1
(43) Pub. Date: May 13, 2010

(54) Ceramic matrix composite surfaces with open features for improved bonding to coatings

(75) Inventors: Gary B. Merrill, Orlando, FL (US); Jay A. Morrison, Oviedo, FL (US); Jay E. Lane, Mims, FL (US); Steven James Vance, Oviedo, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/600,709

(22) Filed: Nov. 16, 2006

(51) Int. Cl. B32B 3/30; B05D 3/12

(52) U.S. Cl. 428/156; 427/177

(57) ABSTRACT

A method to form an improved hybrid ceramic matrix composite structure comprises providing a ceramic matrix composite (CMC) with open features at a surface and applying a thermal barrier coating to the surface. The thermal barrier coating is preferably a friable graded insulation coating (FGI) having hollow ceramic spheres. For acceptance of a FGI coating the open features have a center-to-center separation distance in one or more directions that is between about 100 and about 1,000 percent of the diameter of the hollow ceramic spheres in the FGI and a depth that is between about 20 percent and about 200 percent of the diameter of the hollow ceramic spheres in the FGI. The open feature can result from the winding of tows about a mandrel; the lay-up of fabric including a surface fabric having an open weave; or the use of a 3-D weave, or a 3-D braid.

### FIELD OF THE INVENTION

The present invention relates to ceramic matrix composite surfaces that are bonded to a coating, especially an insulation coating.

### BACKGROUND OF THE INVENTION

Parts made from ceramic matrix composite (CMC) materials permit higher operating temperatures than do metal alloy materials due to the inherent nature of ceramic materials. High temperature environments such as state of the art turbine engines require such materials. This high temperature capability translates into reduced cooling requirements, resulting in higher power, greater efficiency, and reduced emissions from the machine. A high temperature insulation for ceramic matrix composites referred to as a friable graded insulation (FGI) has been developed. This oxide-based insulation system is dimensionally and chemically stable at a temperature of approximately 1600° C.

Turbine structures are exposed to hot combustion gases having temperatures that would normally cause rapid degradation or melting of the material. Thus, cooling is required to maintain the material temperatures to acceptable levels.

CMCs offer higher temperature capability than metals, but in the most extreme cases must also be aggressively cooled. A FGI provides excellent insulating and abrading characteristics by the presence of hollow ceramic spheres distributed through a continuous phase. The insulating characteristics permit dramatic reductions on cooling required for CMC hot turbine components. This structure of FGI is particularly useful with a CMC as the coefficients of thermal expansion are very similar.

Failure of these parts can occur by failure of the bond between the FGI coating and the CMC surface. Current CMC articles display a smooth surface where the FGI coating is to be fixed. Interface induced defects can lead to catastrophic spallation of the abradable coating as crack propagation can proceed in an unimpeded path at the smooth plane of the interface.

Air-plasma-sprayed thermal barrier coatings are used with rough bond coatings on metallic substrates. The rough bond coatings provide a thermal expansion gradient but also provide a site of mechanical interlocking with the thermal barrier coating as well as an increased bond surface area and a non-planar crack propagation path. Such bond coatings are not desirable for the adherence of an FGI to a CMC surface due to the small scale of their roughness. However, the features of increased bond surface area and a non-planer crack propagation path are desirable.

### SUMMARY OF THE INVENTION

This invention is directed to a method forming a hybrid ceramic matrix composite structure for use in turbine engines. The method of forming a hybrid ceramic matrix composite structure may include forming a ceramic matrix composite (CMC) with open features at one or more surfaces and then applying a thermal barrier coating to the surfaces. The thermal barrier coating may be a friable graded insulation coating (FGI) containing hollow ceramic spheres. The open features may have a center-to-center separation distance in one or more directions that is between about 100 percent and 1,000 percent of the outside diameter of large hollow ceramic spheres in the FGI and a depth that is between about 20 percent and about 200 percent of the diameter of large hollow ceramic spheres in the FGI.

The open features on the CMC surface can be formed by winding a ceramic filament, where the winding angle, repeat pattern, and filament tow size may be selected to yield the shape and size of the open features to accept the spheres of the FGI. The open features may be bordered by tapered ribs or ribs having a lip for mechanical locking of the thermal barrier coating. The open features can be formed when the CMC is formed via a fabric lay-up with one or more layers of fabric at the surface having a two-dimensional open weave where spacing between tows, or bundles of tows, yield the open features to accept the spheres of the FGI. The open weave can have open features that are triangular, rectangular, pentagonal, hexagonal, or any other regular shape resulting from crossed tows. The CMC can be formed by using a two-dimensional open weave fabric placed over one or more layers of a two-dimensional closed weave fabric.

Alternatively, the open weave at the surface could be created by filament winding one or more layers onto the two-dimensional closed weave fabric. A CMC can be formed by using a three-dimensional weave wherein the open features result from the peaks and valleys inherent to the exit and reentry of the tows parallel to the thickness of the weave at the surfaces of the weave. The three-dimensional weave can be an orthogonal weave or an angle-interlocking weave. A CMC can be formed by using a three-dimensional braid. The open layers of CMC at the surface can be formed by applying a thin layer of a three-dimensional weave or braid with open features as described previously onto the surface of a perform made with a two-dimensional closed weave fabric or with a two dimensional closed filament wound form.

### BRIEF DESCRIPTION OF THE DRAWINGS

FIG. 1 is a schematic diagram illustrating the relationship of the large spheres of the FGI and the open features of the CMC with 2 open features equal to the diameter of the spheres, D, and the depth of the open feature equal to 0.2D, and 4 the open features equal to 10D, and the depth of the open features equal to 2 D.

FIG. 2 is a schematic diagram of open features generated by winding with a triangular rib formed by stacked filaments.

FIG. 3 is a schematic diagram of open features with interlocking ridges.

FIG. 4 is a schematic diagram of a two dimensional square open weave with open features resulting from the tow spacing of approximately the diameter of the tow.

FIG. 5 is a schematic diagram of a three dimensional weave where the open features result from the spacing required for the exit and reentry of the tow that exits and reenters parallel to the thickness of the CMC.

FIG. 6 is a schematic diagram of a three dimensional braid.

### DETAILED DESCRIPTION OF THE INVENTION

The invention is directed to the achievement of an interface between the CMC surface and a thermal barrier coating, particularly a FGI coating, such that an increased bond surface area with a non-planar crack propagation path occurs. An

FGI coating contains hollow ceramic spheres to enhance thermal insulation. The invention provides features for a mechanical interlocking of the CMC and the FGI. The invention is directed to a CMC surface that is not smooth and has features with dimensions that are sized to partially or completely accept the ceramic spheres in a FGI thermal barrier coating. A smooth surface of the CMC is avoided by controlling the nature of the filament or fabric structure used to produce the CMC. This modified structure can extend through the entire thickness of the CMC structure or it can be imposed only to a relatively shallow depth at the surface of the structure.

The cross-sectional area of the void and the depth of the open features are produced in a manner to partially or completely accept the largest ceramic spheres in the FGI. The open feature is designed to permit the largest sphere to penetrate and contact the base of the open feature. The depth of the open feature permits effective insertion of the largest sphere of the FGI coating.

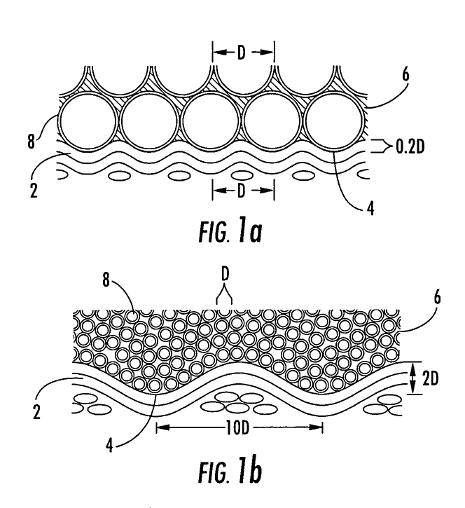

The following criteria for cross-sectional area and depth of these void features are preferable to achieve the desired fit of spheres to enhance bonding and avoid characteristics of the interface that can promote crack propagation and delamination. As illustrated in FIG. 1, the distance between bases of the open features 4 must be equal to or grater than the diameter, D, of the largest sphere 8 to about an order of magnitude greater, 10D, than the largest sphere's diameter. Distances that are less than the sphere's diameter will permit large spheres to touch each other in a manner that does not permit the sphere's surface to effectively extend into the open feature 4. When the spheres 8 cannot extend into the open feature 4, there exists an increased probability for the formation of a planar crack propagation path adjacent to the interface of the CMC 2 and the FGI 4.

The depth of the open feature 4 must permit sufficient penetration such that the largest sphere 8 can be in contact with the base of the open feature 4 without extending above the feature in a manner that inhibits the contact of adjacent spheres with the base of adjacent features. Small depths of these features would result in only a very small contact of a sphere 4 with the base of the open feature, which in the limit of a smooth surface would be only a point. More contact between the sphere 8 and the base reduces the probability that a nearly planar path for crack propagation exists. To achieve high levels of contact between spheres 8 and the surface of the open feature 4 this depth of the open feature 4 should be at least 20 to about 200% of the diameter of the largest sphere or 0.2 D and 2 D as shown in FIG. 1. The open feature spacing and depth are required features for any CMC 2 surface for adherence to a FGI 6 regardless of the mode in which these open features 4 are generated.

Filament winding is one method of forming CMC structures with open features according to the invention, although other methods are possible. By controlling the winding parameters a continuous matrix impregnated filament can be wrapped around a rotating mandrel with the precise placement of many composite layers. The mandrel can be any shape that does not have re-entrant curvature and is not limited to axis-symmetric structures. Controlling the winding parameters such as the winding angle, repeat pattern, filament tow size, filament tension, and band width can generate a surface with open features. The open features are a result of a winding pattern that leaves voids that extend from the surface to a depth that is a multiple of the tow diameter depending upon the multiple of winding levels that are not continuously filled.

The winding pattern can form the open features, alternately described as pockets, recesses, cavities, etc. Ribs can be formed from the filaments positioned by the winding process and can have essentially any depth depending on the filament thickness and the number of windings. The winding pattern can be carried out to form tapered ribs where the base of the rib is formed from a multiple of adjacent contacting filaments that is greater than the number of adjacent contacting filaments on ascending layers of the rib.

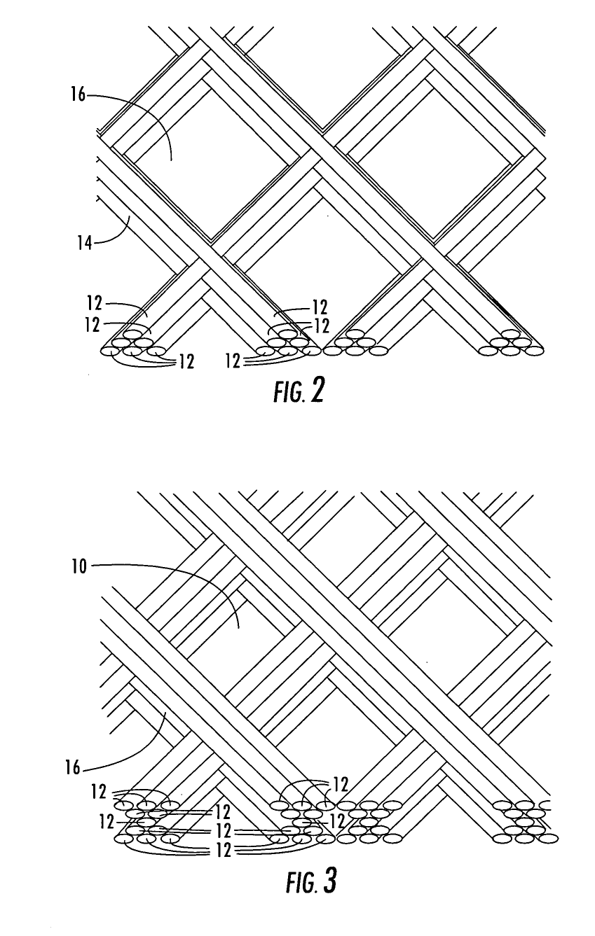

For example, FIG. 2 shows an open feature 10 where the top six windings comprise a square pattern where three filaments 12 are wound parallel to each other, followed by three filaments 12 wound perpendicular to first three filaments 12, followed by the subsequent winding of two filaments 12, two filaments 12, one filament 12, and finally one filament 12 where each successive layer of filament is wound perpendicular to the layer below as one ascends the layers defining a tapered rib 14 of approximately three filament diameters in height. The rib can form an interlocking ridge 16 by decreasing and then increasing the number of adjacent contacting filament layers as the rib ascends as shown in FIG. 3. In this case the filament pattern has the ascending pattern as in FIG. 2, followed by winding two filaments 12, two filaments 12, three filaments 12, and a finally three filaments 12 as one ascends the layers. In this manner the filaments overlap part of the open feature permitting the FGI to be partially encapsulated by the wound structure to mechanically lock the FGI surface to the CMC surface. The filaments 12 can be of any shape and size and variations in size of the filaments can be used. Open features 10 can result from a single layer of filament windings to six or more windings. Any winding pattern that results in open feature of the size conducive to the acceptance of the largest spheres of the FGI, as indicated above and in FIG. 1 can be used.

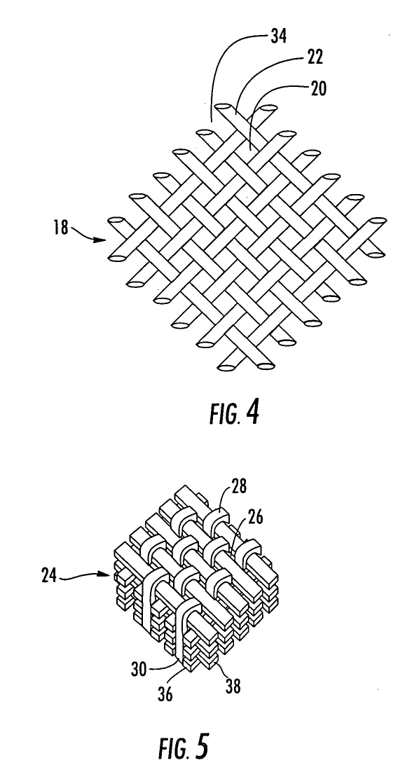

A second embodiment of a CMC structure according to the invention is constructed by a fabric lay-up technique where the features of the fabric used at the surface defines the size and shape of the open features. The use of what is commonly known as a two-dimensional open plain weave 18, shown in FIG. 4, gives a CMC surface where the open feature 20 has a square or rectangular opening with dimensions defined by the tow spacing 34 of the weave and a minimum depth defined by the thickness of the tows 22 of the fabric. The open weave fabric can be used as only the top fabric layer of the composite or it can be used for multiple or all of the layers. Where more than one layer is used the depth of the open feature can be greater than the thickness of a single fabric layer. The effective wall of the open feature can be but is not necessarily normal to the surface, and the effective wall can be curved or irregular. Fabrics with other weaving patterns can be used that give alternate shapes to the open features at the surface depending upon the tow size, warp/weft over/under spacing, tow twist and other features employed during the weaving process. The open features 4 should be matched to the size of the largest spheres 8 of the FGI coating 6 as indicated above and in FIG. 1. The open features 10 can be square, triangular, rectangular, pentagonal, hexagonal or any other regular or irregular shape. The CMC can be constructed where fabric on the interior or on one face is a closed weave and only the surface or surfaces to be bound to the thermal barrier coating are from one or more layers of an open weave fabric 18.

A third embodiment of the invention comprises a three-dimensional weave that can inherently yield open features for accepting the spheres of an FGI coating. FIG. 5 illustrates a plain 3-D weave 24. In this form the fabric has high exit and reentry sites 28 and open features 26 defined by the manner that the z dimension tows 30 exit and reentry between the x dimension tows 36 and y dimension tows 38. The diameter and shape of the tows in the three dimensions can be of equal or different diameter. The requirement is that the open features 26 as indicated above can accommodate the spheres 8 of the FGI 6 shown in FIG. 1. Any three-dimensional weave pattern, such as an orthogonal weave or an angle interlocking weave, can be used where the size and shape of the open features inherent to the weave can accept the spheres of an FGI coating in the manner described above.

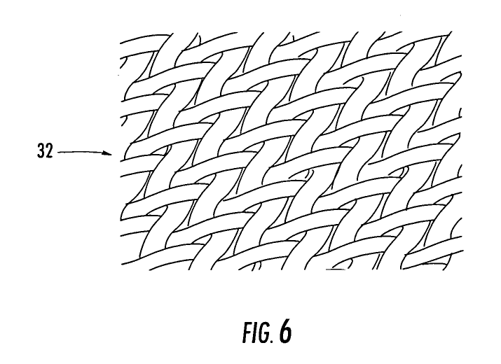

A three-dimensional braided structure for the fabric can be used to provide open features. Such 3D braids typically are optimized to have a dense structure in the interior but necessarily have a course-braided exterior. In this embodiment the size of the cross-section of the open feature and the depth of the feature is defined by the structure of the braid. A braid 32 is illustrated in FIG. 6. Such braids provide an inherent coarseness to the surface, providing the open features required in the present invention. Depending upon the controls during the weaving process, the open features can vary in cross-section and depth.

The formation of a surface architecture of a CMC with multiple and regular voids that are of sufficient dimensions to accommodate the ceramic spheres of a FGI coatings can be constructed. In this manner the adhesion of the coating to the CMC is improved via an enhanced surface area where voids permit an interpenetration and possible interlocking of the two materials. The formation of the surface with voids can be made by winding, weaving, or braiding as long as the center-to-center separation distance in one or more directions of voids in the CMC are at least as large as the largest sphere in the FGI and the depth of the void is at least 20% of the diameter of the largest sphere.

While the preferred embodiments of the invention have been illustrated and described, it will be clear that the invention is not so limited. Numerous modifications, change, variations, substitutions and equivalents will occur to those skilled in the art without departing from the spirit and scope of the present invention as described in the claims.

1. A method to form a hybrid ceramic matrix composite structure, comprising the steps of :
providing a ceramic matrix composite (CMC) with open features at one or more surfaces; and
applying a thermal barrier coating to said surfaces.

2. The method of claim 1, wherein said thermal harrier coating is a friable graded insulation coating (FGI) having hollow ceramic spheres.

3. The method of claim 2, wherein said open features have a center-to-center separation distance in one or more directions that is 100 to 1,000% of the diameter of said hollow ceramic spheres in the FGI and a depth that is 20 to 200% of the diameter of said hollow ceramic spheres in the FGI.

4. The method of claim 1, wherein providing said open features comprises winding of a ceramic filament with a winding angle, a repeat pattern, and a filament tow size to yield said open features.

5. The method of claim 4, wherein said open features are bordered by tapered ribs.

6. The method of claim 4, wherein said open features are bordered by ribs having an interlocking ridge.

7. The method of claim 1, wherein providing comprises a fabric lay-up where one or more layers of a two-dimensional open weave fabric resides at said surface wherein said open features comprise voids between tows or bundles of tows in said two-dimensional open weave fabric.

8. The method of claim 7, wherein said open features are square, triangular, rectangular, pentagonal, hexagonal, any other regular or irregular shape resulting from crossed tows.

9. The method of claim 7, wherein said two-dimensional open weave fabric is layed-up over one or more layers of a two-dimensional closed weave fabric.

10. The method of claim 1, wherein the providing comprises the use of a three-dimensional weave fabric wherein said open features are voids between exit and reentry sites of the tows parallel to the thickness of said fabric.

11. The method of claim 10 wherein said three-dimensional weave fabric is an orthogonal weave or an angle interlocking weave.

12. The method of claim 1, wherein said providing comprises the use of fabric formed as a three-dimensional braid.

13. A hybrid ceramic matrix composite structure comprising:
a shaped ceramic matrix composite with a surface having open features;
a friable graded insulation coating on the surface of the shaped ceramic matrix composite, wherein the friable graded insulation coating includes hollow ceramic spheres;
wherein the open features in the surface of the shaped ceramic matrix composite are sized such that a largest sphere of the hollow ceramic spheres is sized to contact a base of the open features; and
wherein at least one of the open features includes a hollow ceramic sphere in contact with the base of the at least one open feature.

14. A structure of claim 13, wherein the open features have a center-to-center separation distance in one or more directions that is 100 to 1,000% of a diameter of said hollow ceramic spheres in the friable graded insulation coating, and the open features have a depth that is 20 to 200% of the diameter of said hollow ceramic spheres in the friable graded insulation coating.

15. The structure of claim 13, wherein said open features are formed from voids that result from winding of a filament with a winding angle, a repeat pattern, and a filament tow size to yield said open features.

16. The structure of claim 15, wherein said open features arc bordered by tapered ribs.

17. The structure of claim 15, wherein the open features are bordered by ribs having an interlocking ridge.

18. The structure of claim 13, wherein a said open features comprise voids between tows or bundles of tows in a two-dimensional open weave fabric.

19. The structure of claim 18, wherein the open features are square, triangular, rectangular, pentagonal, hexagonal, any other regular or irregular shape resulting from crossed tows.

20. The structure of claim 13, wherein said open features comprise voids between exit and reentry sites of the tows parallel to the thickness of a three-dimensional weave fabric.

21. The structure of claim 20 wherein said three-dimensional weave fabric is an orthogonal weave or an angle interlocking weave.
